(19) United States
(12) Patent Application Publication
(10) Pub. No.: US 2026/0093721 A1
(43) Pub. Date: Apr. 2, 2026

(54) MACHINE-READAEBLE MEDIA FOR CREATING A DATABASE OF TEXT RECORDS OF A HIERARCHICAL CLASSIFIER WITH SEVERAL LEVELS OF NESTING

(71) Applicant: Anna Valerevna Chernyeva, Moscow (RU)

(72) Inventor: Maxim Andreevich Chernyaev, Moscow (RU)

(21) Appl. No.: 19/288,987

(22) Filed: Aug. 2, 2025

(30) Foreign Application Priority Data
Sep. 27, 2024 (RU) 2024128776

(51) Int. Cl. G06F 16/31; G06F 40/14

(52) U.S. Cl. CPC G06F 16/322; G06F 40/14

(57) ABSTRACT

In a preferred embodiment claimed a machine-readable media containing instructions executed by a processor of a computing device, wherein instructions executes the following steps: identify a set of unique text records of a hierarchical classifier with one level of nesting, and each unique text entry is associated with a unique title; Each unique title contains a list consisting of at least many unique subheadings; associate the mentioned identified unique text entries with one of the mentioned unique subheadings to obtain a plurality of associated text entries; a database of text records of a hierarchical classifier with several levels of nesting is formed, containing at least a set of the mentioned associated text records, with each of which at least one first sign of connectivity is associated, and each first sign of connectivity corresponds to one of the mentioned subheadings and the sign of connectivity is a unique identifier of one of the mentioned subheadings.

### FIELD OF THE INVENTION

The present technical solution pertains to the field of digital technologies, specifically to methods for generating text record databases of a hierarchical classifier with multiple levels of nesting.

### BACKGROUND

In the traditional trademark application process, selecting the correct list of goods and services, accurately reflecting the required goods and/or services, and thus appropriately choosing classes in accordance with the International Classification of Goods and Services (ICGS), is relatively complex.

Generally, this process's complexity is due to the necessity of possessing specific professional knowledge related to trademark registration, making it practically impossible for individuals without such skills to properly prepare the documentation.

Additionally, in the current trademark application process, the selection of goods and services involves a search using exact or fuzzy words within the entire list of the Nice Classification to find similar results. However, users who are unfamiliar with the structure of the Nice Classification may find it challenging to locate the correct and relevant entries that identify goods and services. They may also overlook essential items needed for properly forming a trademark application (or service mark). For example, a clothing store owner may not know that they actually need “wholesale and retail sale of clothing.” Instead, they may attempt to find specific items in categories themselves, such as “women's clothing, men's clothing, shirts.”

On the other hand, in the context of business globalization, many companies and brands focused on international business place significant importance on the demand for trademarks and their protection. These companies and brands often register trademarks in multiple countries to protect their brand identity, ensuring uniqueness and recognizability worldwide. However, trademark laws and classification systems for trademarks may vary by country. Therefore, during the international registration of a trademark, issues often arise regarding the proper formation of goods and services concerning the requirements of a specific country's classifier.

In application TW 202349324 A (AIPLUX TECHNOLOGY CO LTD, 16.12.2023), a solution is proposed that involves creating a converter for the ICGS classifier that takes into account the enforcement regulations of the country where the trademark application is intended. This solution includes an electronic user-controlled device connected to a server, where specialized software implements an online trademark application module, allowing the user to enter the necessary information to file a trademark application. When the user selects the international trademark application option and specifies at least one additional country for the application, the processor activates a category conversion module in the application software.

The main disadvantage is its reliance on specific classifier formulations and the lack of automated selection of goods and services from the classifier for the required field when preparing a trademark registration application without the need to review the entire goods and services classifier.

### SUMMARY

The proposed technical solution addresses the issue of creating a more comprehensive and accurate classifier of goods and services, enabling the formation of hierarchical links for subsequent automated selection of required goods and services.

The technical result is the automation of the formation of the list of goods and services and the improvement of accuracy in forming the list of goods and services through the application of hierarchical interconnections using associated record features

In a preferred embodiment claimed a machine-readable media containing instructions executed by a processor of a computing device, wherein said instructions executes the following steps: identifying a plurality of unique text records in a hierarchical classifier with a single level of nesting, where each unique text record is associated with a unique header; each unique header contains a list of at least a set of unique sub-headers; associating the identified unique text records with one of the mentioned unique sub-headers to obtain a set of associated text records; forming a database of text records in a hierarchical classifier with multiple levels of nesting, containing at least the mentioned set of associated text records, with each of which at least one first association feature is associated, where each first association feature corresponds to one of the mentioned sub-headers.

In one specific embodiment, the first association feature is a unique identifier of one of the mentioned sub-headers.

In another specific embodiment, the set of unique sub-headers includes the first unique sub-headers and the second unique sub-headers.

In another specific embodiment, at least one unique header is associated with at least a second unique header.

In another specific embodiment, the association is made by associating the unique identifier of the first unique sub-header with the unique identifier of the second unique sub-header to obtain at least the first associated unique sub-header and the second associated unique sub-header.

In another specific embodiment, the associated unique sub-headers are not each associated with the same unique header.

In another specific embodiment, when an associated text record is associated with the first associated unique sub-header, such a text record is also associated with the second associated unique sub-header, with which the mentioned first associated unique sub-header is associated.

In another specific embodiment, the database of text records in a hierarchical classifier with multiple levels of nesting contains at least the mentioned set of associated text records, with each of which multiple association features are associated.

In another specific embodiment, the number of association features corresponds to the number of associated unique sub-headers, with these associated unique sub-headers being interconnected.

In another specific embodiment, the associated unique sub-headers are not each associated with the same unique header.

In another specific embodiment, the set of associated text records includes a set of first associated text records and a set of second associated text records.

In another specific embodiment, at least one second associated text record is associated with at least one second association feature.

In another specific embodiment, the second association feature is a unique identifier of one of the first associated text records.

In another specific embodiment, the second associated text record is associated with the same associated unique sub-header as the first associated text record, with which the second associated text record is associated.

In another specific embodiment, at least part of the set of unique text records is obtained from at least one list of goods and services of a published trademark application or a registered trademark.

In another specific embodiment, at least part of the set of unique text records is obtained from at least one list of goods and services of a published trademark application or a registered trademark.

In another specific embodiment, at least part of the set of unique text records is obtained from at least one list of goods and services of a published trademark application or a registered trademark.

In another specific embodiment, at least part of the set of unique text records is obtained from at least one list of goods and services of a published trademark application or a registered trademark.

Further specific embodiments of the claimed invention will be presented in the following application materials.

### BRIEF DESCRIPTION OF DRAWINGS

FIG. 1 illustrates a method for creating a database of unique entities.

FIG. 2 illustrates the database request process.

FIG. 3 illustrates a method for generating a list of goods and/or services using the database.

FIG. 4 illustrates an example of a computing device.

### DETAILED DESCRIPTION OF THE INVENTION

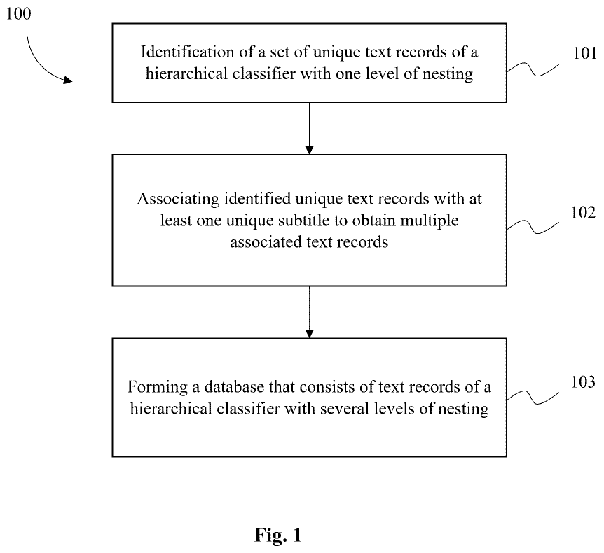

As shown in FIG. 1, the proposed solution includes a method (100) for creating a multi-level hierarchical database of text records. The method involves identifying (101) a set of unique text records in a single-level hierarchical classifier, which can be, for instance, an ICGS or any other classifier that has only one level of hierarchy, where entities are directly assigned to a class without intermediate levels. For example, each record in the ICGS, which is unique and identifies a specific product or service, is associated with a unique heading that provides a general description of the product or service class, such as ICGS Class 9, “Measuring and signaling equipment.”

Each unique heading contains a list comprising at least a set of unique subheadings, which represent specific product or service names, such as:
90151—Electrical observation and control equipment, except for medical purposes;
90149—Stamp payment control devices;
90067—Comparators;
90240—Material testing machines and instruments.

The description of each subheading is a unique text record that is associated (102) with one of the mentioned unique subheadings through a connectivity feature, which could be, for example, an identifier (ID) of the subheading, such as 90151, 90149, 90067, etc. This results in a set of associated text records. Using the associated data, a multi-level hierarchical database (103) is created, containing at least a set of the associated text records, with each record being linked to at least one first connectivity feature, where each first connectivity feature corresponds to one of the mentioned subheadings.

Some unique subheadings may be interlinked due to corresponding products or services that match different unique subheadings but share the same application field and are homogeneous. For example, the field “software” may include direct products in Class 9 ICGS, services for software development in Class 42, and software licensing services in Class 45 ICGS.

For association without specifying individual products and services, homogeneous products and services are linked by connecting their unique subheadings. This association is carried out by linking the unique identifier of the first unique subheading with the unique identifier of the second unique subheading, resulting in at least the first and second associated unique subheadings. In this case, the associated unique subheadings are not linked to the same unique heading.

If an associated text record is linked to the first associated unique subheading, then it is also linked to the second associated unique subheading, which is associated with the mentioned first associated unique subheading.

Through the association of unique text records, the created multi-level hierarchical classifier database contains at least a set of associated text records, each linked to multiple connectivity features. The number of such connectivity features corresponds to the number of associated unique subheadings, which are linked to each other. Additionally, the associated unique subheadings are not all linked to the same unique heading.

The set of associated text records may include sets of first and second associated text records, where at least one second associated text record is linked to at least one second connectivity feature, which may be a unique identifier of one of the first associated text records. Moreover, the second associated text record may be linked to the same associated unique subheading as the first associated text record linked to it.

The set of associated text records may include multiple first associated text records and multiple second associated text records. At least part of the set of unique text records may be obtained from at least one list of goods and services from a published trademark application or a registered trademark. The set of unique subheadings may include first unique subheadings and second unique subheadings.

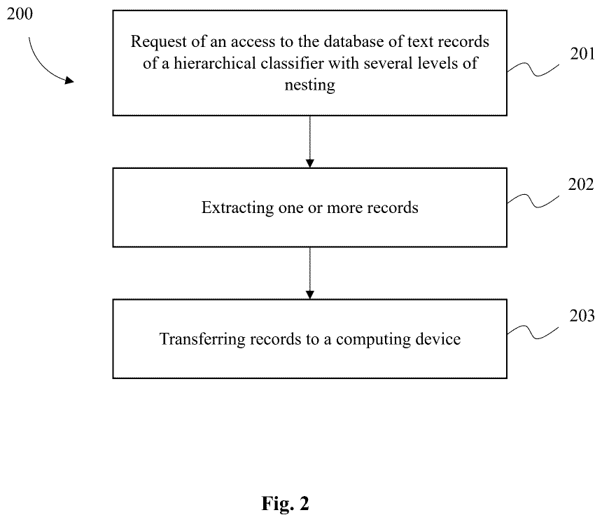

As shown in FIG. 2, the database created in the above manner is used for automated access (200) to unique associated text records when forming a list of goods and services by retrieving stored data. Initially, an access request (201) is made via a computing client or server device, followed by database access to retrieve (202) at least the first associated text record and at least the first unique subheading, the unique identifier of which serves as the first connectivity attribute of the retrieved first associated text record. The retrieved record is transferred (203) to the device that submitted the database access request to execute the retrieval process. The retrieved record may be displayed in a graphical interface implemented on the computing device or directly transferred for further creation of a list of goods and/or services.

Additionally, a second unique subheading associated with the retrieved first unique subheading may be retrieved. Furthermore, at least one other first associated text record associated with the retrieved second unique subheading may also be retrieved. Additionally, the retrieval may include at least the first associated text record and at least the second associated text record associated with the retrieved first associated text record.

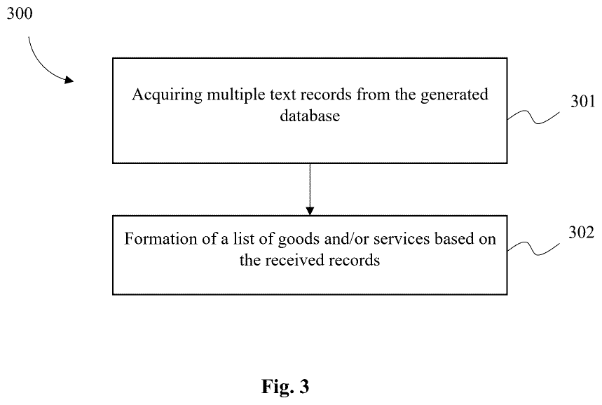

FIG. 3 presents a method (300) for forming a list of goods and services using the created database of associated records. As part of this method, following the implementation of method (200), the identification (301) of a set of text records retrieved from the database takes place, after which a list of goods and/or services (302) is formed. In this list, text records are listed using a delimiter, such as a semicolon (“;”) followed by a space, which is required because, typically, in the preparation of a trademark application, the list of goods and services must be formatted in this way. However, a specialist in this technical field will understand that any suitable delimiter may be used, provided it meets the requirements of the trademark application or enables the electronic trademark application system to process the electronic file containing the list of goods or services.

The set of extracted text records may include at least one of or any combination of:
The first associated text record linked to the first unique subheading;
The first unique subheading;
The second unique subheading;
The first associated text record linked to the second unique subheading;
The first associated text record linked to the first unique subheading,
The first unique subheading,
The second unique subheading,
The first associated text record linked to the second unique subheading,
The second associated text record linked to the first associated text record.

The generated list of products and/or services is then displayed on the user's computing device, server device, or in a web interface when using a web browser to access the listing. Additionally, the generated list may be automatically saved in a structured XML file.

The implementation of the solution, including creating the database, extracting data from it, and related processes, can be carried out using a computing device such as a personal computer, server, distributed server system, or in a client-server format.

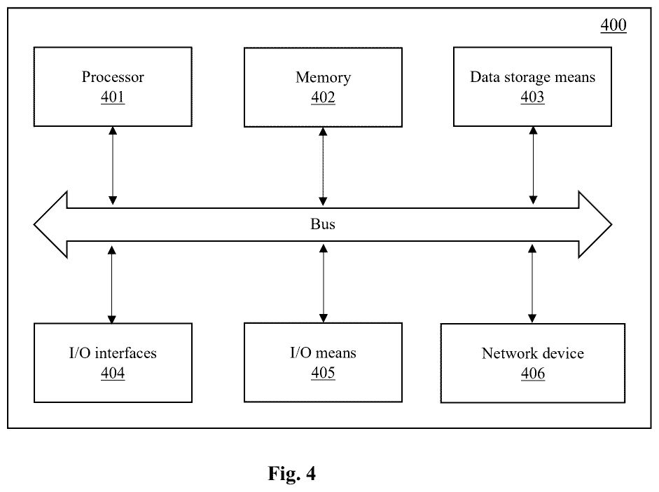

FIG. 4 illustrates a general example of a computing device (400), such as a computing unit (computational module), computer, server, laptop, smartphone, System-on-a-Chip (SoC), etc., which can be used for complete or partial implementation of the claimed solution, particularly for implementing methods (100, 200, 300). Generally, the device (400) includes components such as: one or more processors (401), at least one random access memory (RAM) (402), a data storage means (403), input/output interfaces (404), including relay outputs for connection to conveyor belt motion control controllers, I/O means (405), and networking means (406).

The processor (401) of the device performs the main computational operations required for the device (400) or one or more of its components to function. The processor (401) executes necessary machine-readable instructions contained in the RAM (402).

The memory (402) is generally implemented as RAM and contains the necessary program logic to provide the required functionality. The data storage means (403) may be implemented as HDD, SSD, RAID arrays, network storage, flash memory, or optical storage (CD, DVD, MD, Blu-ray discs), etc. The storage means (403) enables long-term storage of various types of information, such as request processing history (logs), user identifiers, camera data, images, etc.

Interfaces (404) are standard means for connecting and working with computing devices. These interfaces (404) may include, for example, relay connections, USB, RS232/422/485, RJ45, LPT, UART, COM, HDMI, PS/2, Lightning, FireWire, etc., supporting protocols such as Modbus and Probfibus networks. The choice of interfaces (404) depends on the specific implementation of the device (400), which may represent a computing unit (computational module) based on a CPU (one or more processors), microcontroller, personal computer, mainframe, server cluster, thin client, smartphone, laptop, etc., as well as any external connected devices.

The I/O means (405) may include a keyboard, joystick, display (touchscreen), projector, touchpad, mouse, trackball, light pen, speakers, microphone, etc.

Networking means (406) are selected from devices providing network reception and transmission of data, such as an Ethernet card, WLAN/Wi-Fi module, Bluetooth module, BLE module, NFC module, IrDa, RFID module, GSM modem, etc. The means (406) enable data exchange through wired or wireless transmission channels, such as WAN, PAN, LAN, Intranet, Internet, WLAN, WMAN, GSM, quantum data channels, satellite communication, etc. The components of the device (400) are generally interconnected through a common data bus.

The materials presented in this application describe a preferred embodiment of the claimed technical solution, which should not be considered as limiting other specific implementations that fall within the scope of the requested legal protection and are obvious to experts in the relevant technical field.

1. A machine-readable media containing instructions executed by a processor of a computing device, wherein said instructions executes the following steps:
identifying a plurality of unique text records of the hierarchical classifier with a single level of nesting, wherein each unique text record is associated with a unique header, wherein each unique header contains a list consisting of at least a plurality of unique subheaders;
associating the identified unique text records with one of the mentioned unique subheaders to obtain a plurality of associated text records;
forming a database of text records of the hierarchical classifier with multiple levels of nesting, containing at least the plurality of mentioned associated text records, each of which is associated with at least one first linkage characteristic, wherein each first linkage characteristic corresponds to one of the mentioned subheaders.

2. The machine-readable media of claim 1, wherein the first linkage characteristic is a unique identifier of one of the subheaders.

3. The machine-readable media of claim 1, wherein the plurality of unique subheaders includes first unique subheaders and second unique subheaders.

4. The machine-readable media of claim 3, wherein at least one first unique header is associated with at least one second unique header.

5. The machine-readable media of claim 4, wherein the association is performed by associating the unique identifier of the first unique subheader with the unique identifier of the second unique subheader to obtain at least the first associated unique subheader and the second associated unique subheader.

6. The machine-readable media of claim 5, wherein the associated unique subheaders are not each associated with the same unique header.

7. The machine-readable media of claim 6, wherein when the associated text record is associated with the first associated unique subheader, such a text record is also associated with the second associated unique subheader, with which the mentioned first associated unique subheader is associated.

8. The machine-readable media of claim 7, wherein the database of text records of the hierarchical classifier with multiple levels of nesting contains at least the plurality of mentioned associated text records, each of which is associated with multiple linkage characteristics.

9. The machine-readable media of claim 8, wherein the number of linkage characteristics corresponds to the number of associated unique subheaders, wherein such associated unique subheaders are associated with each other.

10. The machine-readable media of claim 7, wherein the associated unique subheaders are not each associated with the same unique header.

11. The machine-readable media of claim 1, wherein the plurality of associated text records includes a plurality of first associated text records and a plurality of second associated text records.

12. The machine-readable media of claim 10, wherein at least one second associated text record is associated with at least one second linkage characteristic.

13. The machine-readable media of claim 11, wherein the second linkage characteristic is a unique identifier of one of the first associated text records.

14. The machine-readable media of claim 12, wherein the second associated text record is associated with the same associated unique subheader with which the first associated text record, with which the second associated text record is associated, is associated.

15. The machine-readable media of claim 1, wherein at least a part of the plurality of unique text records is obtained from at least one list of goods and services of a published trademark application or a registered trademark.

16. The machine-readable media of claim 2, wherein at least a part of the plurality of unique text records is obtained from at least one list of goods and services of a published trademark application or a registered trademark.

17. The machine-readable media of claim 10, wherein at least a part of the plurality of unique text records is obtained from at least one list of goods and services of a published trademark application or a registered trademark.

18. The machine-readable media of claim 11, wherein at least a part of the plurality of unique text records is obtained from at least one list of goods and services of a published trademark application or a registered trademark.
